(19) United States
(12) Patent Application Publication
(10) Pub. No.: US 2008/0171243 A1
(43) Pub. Date: Jul. 17, 2008

(54) Reaction vessel and reaction device

(76) Inventors: Sung-chul Lee, Suwon-si (KR); Ju-yong Kim, Suwon-si (KR); Yong-kul Lee, Suwon-si (KR); Man-seok Han, Suwon-si (KR); Jin-goo Ahn, Suwon-si (KR)

Correspondence Address: ROBERT E. BUSHNELL, 1522 K STREET NW, SUITE 300, WASHINGTON, DC, 20005-1202, US

(21) Appl. No.: 12/007,269

(22) Filed: Jan. 8, 2008

(30) Foreign Application Priority Data
Jan. 12, 2007 (KR) 10-2007-0004001

(51) Int. Cl. H01M 8/06

(52) U.S. Cl. 429/17; 429/19

(57) ABSTRACT

The present invention relates to a reaction vessel for fuel cells, and more particular to a reaction vessel capable of obtaining reaction temperature promptly at the time of initial operation and a reaction device to form a reforming device of the fuel cell using the same. The reaction device of the present invention includes a reaction vessel that includes a monolithic chain. The monolithic chain has a first wall, a second wall, and a layer of pleats interposed between the first wall and the second wall. A plurality of openings are formed on each of the top side and the bottom side of the monolithic chain. One of the first wall and the second wall being made of an insulating material. The layer of pleats is made of a conductive material, and electric power is applied to generate heat at initial reaction operation. Once the reaction is activated, the reaction vessel produces heat through an oxidation reaction.

### CLAIM OF PRIORITY

This application makes reference to, incorporates the same herein, and claims all benefits accruing under 35 U.S.C. § 119 from an application for REACTION VESSEL AND REACTION DEVICE earlier filed in the Korean Intellectual Property Office on the 12 Jan. 2007 and there duly assigned Serial No. 10-2007-0004001.

### BACKGROUND OF THE INVENTION

1. Field of the Invention

The present invention relates to a reaction vessel for a fuel cell, and more particular to a reaction vessel capable of obtaining reaction temperature promptly at the time of initial operation and a reaction device to form reforming device for the fuel cell using the same.

2. Description of the Related Art

A fuel cell is a power generation system used to generate electric energy by electro-chemically reacting hydrogen and oxygen. According to the types of electrolyte used, fuel cells can be categorized into a phosphoric acid fuel cell, a molten carbonate fuel cell, a solid oxide fuel cell, a polymer electrolyte membrane fuel cell, and an alkaline fuel cell, etc. These respective fuel cell types are basically operated on the same principle, but are different in the type of used fuels, catalyst, and electrolytes, etc., as well as operating temperatures. Among the various types of the fuel cells, the polymer electrolyte membrane fuel cell (PEMFC) has several advantages over other fuel cells, including a remarkably high output, low operating temperature, and rapid starting and response. The PEMFC is widely applicable to a mobile power source, such as portable electronic equipment or a transportable power source, such as a power source for automobiles, as well as a distributed power source, such as a stationary power plant used in a house and a public building, etc.

In an electrochemical oxidation reaction generated in an anode electrode of a fuel cell, hydrogen has the best reactivity. And hydrogen is most suitable for fuel of the fuel cell since it generates water and does not discharge a pollutant after reaction with oxygen. However, hydrogen hardly exists in a natural condition, and therefore it may be obtained by reforming other materials. For example, hydrogen may be obtained by reforming a hydro-carbonaceous fuel such as gasoline, diesel, methanol, ethanol, natural gas etc. Further, hydrogen may be easily obtained from a fuel product such as a butane can etc., which are commercially available. Accordingly, if the butane can is used as a fuel supply source of the fuel cell, there is the advantage of supplying fuel by using inner pressure of the butane can.

In order to generate hydrogen from the hydro-carbonaceous fuel, a reformer is provided. The reformer may include a reforming reactor, a water gas shift unit, and a preferential oxidation unit to improve reforming efficiency. The reforming reactor may include a steam reforming reactor and an autothermal reactor.

The each reactor requires a different reaction temperature range depending on a catalyst installed therein. For example, a reaction temperature range of a steam reforming (SR) reaction is different depending on the kind of reforming raw material. If the catalyst is for a hydro-carbonaceous fuel such as butane etc., the reaction temperature range is about 600° C. to 900° C., and if the catalyst is for a methanol fuel, the reaction temperature is about 250° C. to 400° C. Reaction temperature range of a water gas shift (WGS) reaction, which is one of processes to remove carbon monoxide, is about 200° C. to 350° C., and reaction temperature range of a preferential CO oxidation (PROX) reaction is about 100° C. to 250° C. As mentioned above, the temperature required for the reforming reactor is the highest, and the temperature required for the preferential oxidation unit is the lowest. The temperature required for the water gas shift unit is in a range between the temperature for the reforming reactor and the temperature for the preferential oxidation unit.

In order to maintain the reaction temperature of each device, an electric heater is used as a heating device. Further each device can be implemented by a device which burns hydrocarbon fuel by firing it, or burns some of the hydrocarbon fuels by using a catalyst.

In order to maintain heat of reaction, an oxidation reaction unit for heating, which oxidizes some of hydrocarbon fuels by using a catalyst, may be provided separately. The oxidation reaction unit for heating has a catalyst to promote the oxidation reaction therein, and the oxidation reaction unit generates carbon dioxide and steam with a large amount of heat as a result of the oxidation reaction of the hydrocarbon fuel.

The steam reforming reactor reconstitutes steam and hydrocarbon fuel (hereinafter, referred to as butane) to hydrogen molecules and carbon dioxide by resolving them at high temperature atmosphere. The following Reaction Formula 1 indicates the above mentioned process of the steam reforming reactor. Because a hydrogen molecule in high energy state is generated from a water molecule in low energy state, it is an endothermic reaction, but it has the advantage of generating a large amount of hydrogen.

C₄H₁₀+8H₂O [symbol] 4CO₂+13H₂ Reaction Formula 1

The autothermal reforming reactor reconstitutes butane gas and steam to hydrogen molecules and carbon monoxide by reacting butane with oxygen in the air at about the steam reforming reaction temperature. The autothermal reforming reactor generates hydrogen molecules from water molecules like the steam reforming reactor, but it is an exothermic reaction by oxidation of carbon. The Reaction Formula 2 indicates the process of the autothermal reforming reactor.

C₄H₁₀+4O₂ [symbol] 4CO₂+5H₂ Reaction formula 2

In the steam reforming reaction or the autothermal reforming reaction, theoretically, only carbon dioxide is generated, but practically, a large amount of carbon monoxide is also generated by imperfect combustion. In order to reduce the amount of carbon monoxide, the water gas shift unit performs combustion by reaction between carbon monoxide and steam, and generates hydrogen molecules from water molecules. The Reaction Formula 3 indicates the process of the water gas shift unit.

CO+H₂O [symbol] CO₂+H₂O Reaction Formula 3

As another device to reduce the amount of carbon monoxide, the preferential CO oxidation unit performs perfect combustion by reaction between carbon monoxide and oxygen in the air. The Reaction Formula 4 indicates the reaction process of the preferential CO oxidation unit.

CO+1/2O₂ [symbol] CO₂ Reaction Formula 4

Reforming efficiency of the reformer plays an important role in the total efficiency of the fuel cell system. Therefore, it is necessary to rapidly heat each reactor of the reformer, in which chemical reaction is performed, to appropriate temperature required for chemical reaction of the reactor. The reactors include a reforming reactor, a water gas shift unit, and a preferential CO oxidation unit. Also, the each reactor may have a structure to maximize a contact area between gas and a reaction catalyst to promote each chemical reaction at the appropriate high temperature.

Meanwhile, a reactor, which does not have a separate heating means such as an oxidation reactor for heating, may need a means to increase temperature up to reaction temperature at the time of initial operation, in which a reaction can occur by activating an oxidation reaction catalyst installed therein. However, in the case of providing a separate electric heating means, the costs of manufacturing the reactor may increase.

### SUMMARY OF THE INVENTION

The present invention is proposed to solve the above mentioned problems. One of objectives is to provide a device capable of obtaining reaction temperature that is necessary for the reaction between gas and a catalyst at the time of initial operation.

Another objective of the present invention is to provide a reaction vessel and a reaction device capable of having a device for obtaining the initial reaction temperature at relatively low cost.

In one embodiment of the present invention, a reaction vessel to perform a chemical reaction is provided. The reaction vessel comprises a monolithic chain having a first end and a second end, and having a plurality of passages through which a material passes to perform the chemical reaction. The passages are formed in a direction that is not parallel to a path connecting the first end to the second end. The monolith chain includes an insulating film extending from the first end to the second end, and a conductive film extending from the first end to the second end. Specifically, the reaction vessel includes a monolithic chain that may have a first side, a second side facing the first side, a top side, and a bottom side facing the top side. The monolithic chain includes a first wall formed along the first side, a second wall formed along the second side, and a layer of pleats interposed between the first wall and the second wall. The passages are defined by pleats of the layer of pleats, and the passages are formed to have openings on each of the top side and the bottom side. At least one of the first wall and the second wall is the insulating film.

The reaction vessel may further include a first connection terminal formed on the first end of the monolithic chain to be connected to a power supplier, and a second connection terminal formed on the second end of the monolithic chain to be connected to the power supplier.

A catalyst required for the chemical reaction is formed on each of the pleats of the layer of pleats. The layer of pleats may be made of a metal. The layer of pleats also can be made of a heating metal material.

The chemical reaction may be an oxidation reaction, and the catalyst is a material such as PdAl₂O₃, NiO, CuO, CeO₂ and Al₂O₃, Pu, Pd and Pt, or combinations thereof.

A ratio of a total area of the openings formed on the top side of the monolithic chain to a total area of the top side of the monolithic chain is about 40% to 95%. The density of openings formed on the top side of the monolithic chain is about 200 cpi to 1500 cpi.

In another embodiment of the present invention, a reaction device to perform an objective reaction of gas is provided. The reaction device includes an objective reaction catalyst chamber in which the objective reaction is performed by an objective reaction catalyst to promote the objective reaction, and a reaction vessel surrounding the objective reaction catalyst chamber. The reaction vessel includes the monolithic chain that is described above.

The objective reaction catalyst chamber includes a metal monolith that includes a plurality of passages through which the gas flows. The objective reaction catalyst is formed on walls of the passages.

In the case that the objective reaction is a steam reforming reaction, the objective reaction catalyst is made of a material such as Ni/Al₂O₃, Ru/ZrO₂, Ru/Al₂O₃/Ru/CeO₂—Al₂O₃, or combinations thereof. In the case that the objective reaction is a water gas shift reaction, the objective reaction catalyst is made of a material such as Cu, Zn, Fe, Cr, Cr₂O₃/Fe₃O₄, Cu/ZnO/Al₂O₃, or combinations thereof. In the case that the objective reaction may be a preferential CO oxidation reaction, the objective reaction catalyst is made of a material such as Ru, Rh, Rt/Al₂O₃, TiO₂, ZrO₂, Au/Fe₂O₃, or combinations thereof.

In the case that the reaction vessel reforms hydrocarbon fuel to hydrogen gas, the reaction vessel further comprises a fuel preheater to preheat fuel received from the outside by using heat discharged from the oxidation chamber, wherein the fuel preheater has a tube shape surrounding the oxidation chamber.

In another embodiment of the present invention, a method to heat a reforming reactor for use with a fuel cell is provided. The method comprises the steps of heating a catalyst attached on a monolithic chain with an electrical energy by applying power to the monolithic chain in a reaction vessel which has two connection terminals for applying power from a power supplier for a predetermined period when the fuel cell is turn on; heating the reforming reactor with a chemical energy by applying a fuel and an oxidizing agent which is oxidized on the catalyst attached on the monolithic chain.

The catalyst is formed on pleats of a layer of pleats in the reaction vessel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view illustrating a structure of a reaction vessel constructed as an embodiment of the present invention;

FIG. 2A is a side cross-sectional view of a steam reforming reaction device constructed as another embodiment of the present invention;

FIG. 2B is a top view of a steam reforming reaction device shown in FIG. 2A; and

FIG. 3A to 3D are concept views illustrating various other configurations of main part of a reaction vessel constructed as another embodiment of the present invention.

### DETAIL DESCRIPTION OF THE INVENTION

Hereinafter, preferable embodiments according to the principles of the present invention will be described with reference to the accompanying drawings. Here, when one element is connected to another element, one element may be not only directly connected to another element but also indirectly connected to another element via another element. Further, irrelevant elements are omitted for clarity. Also, like reference numerals refer to like elements throughout.

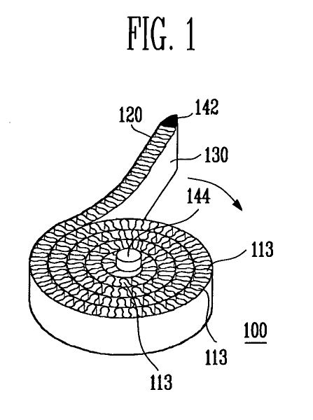

A structure of a reaction vessel of the embodiment of the present invention is illustrated in FIG. 1. A monolithic chain, which has a first end and a second end, is wound around the first end to form cylinder shaped reaction vessel 100. Openings (or cells) 113 are formed on a top and bottom surfaces of the cylindrical reaction vessel 100. The openings of the top surface are connected to the openings of the bottom surfaces through passages formed inside the reaction vessel.

Connection terminals 142 and 144 for applying power from a power supplier are formed at both ends of the monolithic chain. As shown in FIG. 1, first connection terminal 144 is formed at a first end of the monolithic chain that is located at a center of cylindrical reaction vessel 100, and second connection terminal 142 is formed at a second end of the monolithic chain that is located outmost surface of cylindrical reaction vessel 100.

The monolithic chain has a first side, a second side facing the first side, a top side, and a bottom side facing the top side. First wall 130 is formed along the first side of the monolithic chain, and second wall 120 is formed along the second side of the monolithic chain. A layer of pleats, which has a corrugated structure, is interposed between first wall 130 and second wall 120. Pleat tips may contact either of first wall 130 or second wall 120. Therefore, passages are formed along the pleats inside the monolithic chain, and a plurality of openings 113, which are the end portions of the passages, are formed on the top side and bottom side of the monolithic chain.

At least one of first wall 130 and second wall 120 is made of an insulting material, so that electric current, which flows between first connection terminal 144 and second connection terminal 142, is prevented from flowing in the direction of the radius of the cylinder shaped reaction vessel. The pleats of the layer of pleats works as partitions for dividing passages, which are formed between first wall 130 and second wall 120 inside the monolithic chain. The pleats of the layer of pleats are connected to each other forming a corrugated structure. When viewed from the top side of the monolithic chain, the corrugated structure of the layer of pleats may have a shape of a wave or a wrinkle, but the corrugated structure is not limited to a specific shape. The pleats of the layer of pleats can be regularly or irregularly formed.

In the case that the material of the layer of pleats or one of first and second walls 130 and 120 of the monolithic chain is a metal material, the metal material can be iron alloy or aluminum alloy, if economical efficiency is considered. The metal material can be a heating metal material such as Nichrome that has an excellent electric heating performance, if the performance of heating, such as fasting heating, is considered.

As shown in FIG. 1, the reaction vessel has a cylinder shape when the monolithic chain is wound around an axis passing the first end of the monolithic chain in a direction parallel to first wall 130 of the monolithic chain. Therefore, reaction vessel 100 has a top surface that is formed with the wound top side of the monolithic chain, and a bottom surface that is formed with the wound bottom side of the monolithic chain, and an outer wall that is formed with a portion of second wall 120 of the monolithic chain. Therefore, a plurality of openings 113 is formed on the top surface and bottom surface of cylindrical reaction vessel 100. The openings of the top surface of reaction vessel 100 and the openings of the bottom surface of reaction vessel 100 are connected to each other forming passages inside reaction vessel 100. Reaction vessel 100 is designed for a chemical reaction for a fuel cell system. Therefore, a catalyst to promote the chemical reaction is formed on the walls of the passages that are formed inside reaction vessel 100.

When viewed from the top surface of reaction vessel 100, the density of openings 113 formed on the top surface of reaction vessel 100 is about 200 cpi to 1500 cpi (cell per square-inch). If the density of openings 113 is smaller than 200 cpi, reactivity deteriorates due to the decrease of the amount of the catalyst for the chemical reaction. If the density of opening 113 is larger than 1500 cpi, a blocking phenomenon of reacting material is generated.

When viewed from the top surface of reaction vessel 100, the total area of openings 113 formed on the top surface of reaction vessel 100 is about 40% to 95% of the total area of the top surface of reaction vessel 100. If the total area of openings 113 is larger than 95%, reaction vessel 100 may not be sturdy enough, and may have problems in stability at high temperature. In this case, it is also difficult to form the reaction vessel with a metal such as iron or aluminum alloy. If the total area of openings 113 is smaller than 40%, it is difficult to for reaction gas to flow through the reaction vessel, and thereby reaction efficiency deteriorates.

The reaction vessel in FIG. 1 is applicable to reactors of reforming device of a fuel cell system such as an oxidation reactor for heating, a reforming reactor, water gas shift unit, and a preferential CO oxidation unit. Preferably, heating by electric heater is performed only at the time of initial operation. Therefore preferably, the reaction vessel shown in FIG. 1 is applicable to an oxidation reactor for heating, an autothermal reforming reactor, and a preferential CO oxidation unit, which produce an exothermic reaction. In particular, applying the reaction vessel to the oxidation reactor for heating is preferable.

In the case that the reaction vessel is applied to the oxidation reactor for heating, the catalyst formed on passages inside the reaction vessel can be made of a material such as PdAl₂O₃, NiO, CuO, CeO₂ and Al₂O₃ or plutonium (Pu), palladium (Pd), platinum (Pt), methane, or combinations thereof.

In the case that the reaction vessel is applied to the preferential CO oxidation unit, the catalyst formed on passages inside the reaction vessel can be made of a material such as Ru, Rh, Rt/Al₂O₃, TiO₂, ZrO₂ Au/Fe₂O₃, or combinations thereof.

In the case that the reaction vessel is applied to the autothermal reforming reactor, the catalyst formed on passages inside the reaction vessel can be made of a material such as Ru, Rh, Pt—Rh/Al₂O₃, TiO₂, ZrO₂, CeO₂, Ce—Zr composite, Au/Fe₂O₃, or combinations thereof.

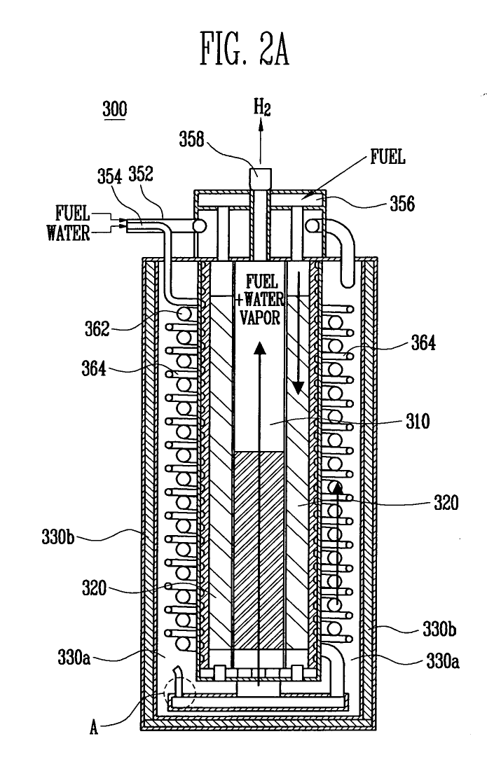

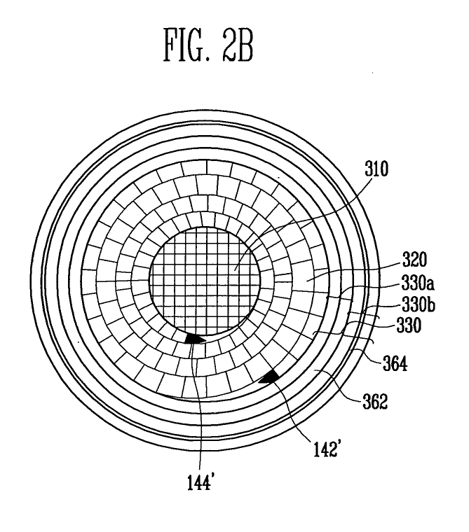

FIGS. 2A and 2B illustrate a steam reforming device using the reaction vessel shown in FIG. 1. FIG. 2A is a side view of the structure of the device, and FIG. 2B is a top view of the structure of the device. The steam reforming device as shown in FIGS. 2A and 2B generates heat by using butane (C₄H₁₀) for reforming material and oxidation fuel for heating, and by oxidizing by using some of butane gas for an oxidation catalyst after receiving water and butane gas from outside. The water is converted into steam by generated heat, and hydrogen gas is produced by reforming butane gas mixed with steam.

The steam reforming device is formed as a cylinder shape, and includes a cylinder shaped steam reforming reaction catalyst chamber 310 and oxidation catalyst chamber 320. In steam reforming reaction catalyst chamber 310, a steam reforming reaction is performed with a steam reforming reaction catalyst to promote the steam reforming reaction. Oxidation catalyst chamber 320 can be built with the monolithic chain as described referring to FIG. 1. In this case, in order to form oxidation catalyst chamber 320, the monolithic chain shown in FIG. 1 is wound around steam reforming reaction catalyst chamber 310, forming a spiral structure around steam reforming reaction catalyst chamber 310.

As shown in FIG. 2B, oxidation catalyst chamber 320 is surrounded by outer wall 330. Outer wall 330 includes first outer wall 330a enclosing oxidation catalyst chamber 320, and second outer wall 330b enclosing first outer wall 330a. First outer wall 330a includes fuel flow pipe 362, in which butane gas fuel flows. The butane gas is supplied through a fuel inlet (not shown). Second outer wall 330b includes water flow pipe 364, in which water flows. The water is supplied through a water inlet (not shown). Each of fuel flow pipe 362 and water flow pipe 364 can be installed in a spiral shape. Heat is generated through oxidation reaction in oxidation catalyst chamber 320. Therefore, the butane gas, which flows through fuel flow pipe 362 for the steam reforming, can be sufficiently preheated before being mixed with steam, and can reserve thermal energy in order to evaporate water that flows through water flow pipe 364.

In other words, outer wall 330 of the steam reforming device functions as a pre-heater to preheat water and butane gas by heat generated from oxidation catalyst chamber 320. In order to prevent waste of heat, outer wall 330 can be constructed to have the waste gas oxidized from the oxidation catalyst 320 pass the space enclosed by the outer wall 330. First wall 330a is used for a region to preheat butane gas, and second wall 330b is used for a region to evaporate water as shown in FIGS. 2A and 2B. The present invention, however, is not limited to this structure shown in FIGS. 2A and 2B. For example, the steam reforming device of the present invention can have a structure that heats only one of water or butane.

Steam reforming reaction catalyst chamber 310 can include a metal monolith as illustrated as square grids in FIG. 2B. The metal monolith has a plurality of openings (or cells) or passages, through which the mixture of butane and steam flow. A catalyst for the steam reforming reaction is formed on walls of the passages formed inside metal monolith. When viewed from the top of steam reforming reaction catalyst chamber 310, which is a cross-section cut perpendicular to the length direction of a cylinder, the density of openings of the metal monolith is about 200 cpi to 1500 cpi (cell per square-inch). The ratio of the total area of the openings to the total area of the cross-section of steam reforming reaction catalyst chamber 310 is about 40% to 95%.

The catalyst formed inside steam reforming reaction catalyst chamber 310 can be made of a material such as Ni/Al₂O₃, Ru/ZrO₂ Ru/Al₂O₃/Ru/CeO₂—Al₂O₃, or combinations thereof. Steam reforming reaction catalyst chamber 310 can rapidly and uniformly transfer heat supplied from oxidation catalyst chamber 320 into the inside of steam reforming reaction catalyst chamber 310. Accordingly, temperature inside steam reforming reaction catalyst chamber 310, in which the butane gas contacts the catalyst, rapidly and uniformly increases up to the steam reforming reaction temperature.

Oxidation catalyst chamber 320 may be manufactured by the structure as illustrated in FIG. 1. The monolithic chain shown in FIG. 1 is wound around steam reforming reaction catalyst chamber 310, and therefore oxidation catalyst chamber 320 may have a donut shape when viewed from the top. Power may be supplied to obtain reaction temperature at initial operation of oxidation catalyst chamber 320 by connecting a power supplier to connection terminals 142′ and 144′, which are provided at both ends of the monolithic chain of oxidation catalyst chamber 320. Heat is generated by electric resistance of the monolithic chain, so that the reaction temperature of initial operation is obtained.

FIGS. 2A and 2B illustrate the steam reforming device embodied that the oxidation catalyst chamber formed of the spiral conductor monolith string heats the steam reforming reaction catalyst chamber according to an idea of the present invention. However, a catalyst chamber for another objective reaction can take place of the steam reforming reaction catalyst chamber depending on an embodiment. In the case of the reforming device of PEMFC, the catalyst chamber for an autothermal reforming reactor, a water gas shift unit and a preferential CO oxidation unit can be used, but preferably a water gas shift catalyst chamber (as the water gas shift unit) may be used since it is an endothermic reaction requiring heat continuously. As mentioned above, in the case of applying to the water gas shift unit, material which mainly has at least one or more material selected from Cu, Zn, Fe, Cr, Cr₂O₃/Fe₃O₄ and Cu/ZnO/Al₂O₃ may be used as the catalyst material.

Hereinafter, a process of reforming butane gas to hydrogen gas in the illustrated steam reforming device will be described.

Some butane gas supplied from the outside is reformed to hydrogen gas, and others are oxidized to supply calories required for the steam reforming reaction to the steam reforming device. The butane gas for heating flows through a gas inlet 356 for heating after being mixed with air, and is transferred to the oxidation catalyst chamber. The mixture of butane gas and air generates heat by oxidation reaction in oxidation catalyst chamber 320, and is converted into carbon monoxide.

The butane gas flows through a fuel inlet 352, and is heated by heat generated by an oxidation reaction in oxidation catalyst chamber 320, while passing through fuel flow pipe 362 encircling oxidation catalyst chamber 320. Water flows through a water inlet 354, and is heated by heat generated by an oxidation reaction in oxidation catalyst chamber 320, while passing through water flow pipe 364 encircling oxidation catalyst chamber 320, and thereby maintaining sufficient thermal energy for evaporation.

The heated water becomes steam by absorbing heat while moving through water 11 flow pipe 364, and the butane gas is preheated while moving through fuel flow pipe 362. The steam and the preheated butane gas are mixed in predetermined region A, and flows into reaction catalyst chamber 310 for the steam reforming.

The steam and the butane gas, flowing into reaction catalyst chamber 310 for the steam reforming, pass through the metal monolith installed inside steam reforming reaction catalyst chamber 310. A catalyst formed on passages inside the metal monolith helps the steam and the butane gas be reformed to hydrogen gas. Oxidation catalyst chamber 320, which surrounds reaction catalyst chamber 310, generates sufficient heat by an oxidation reaction, so that it can maintain temperature for the steam reforming. The hydrogen gas is emitted through an opening 358 installed upper of the reaction catalyst chamber 310.

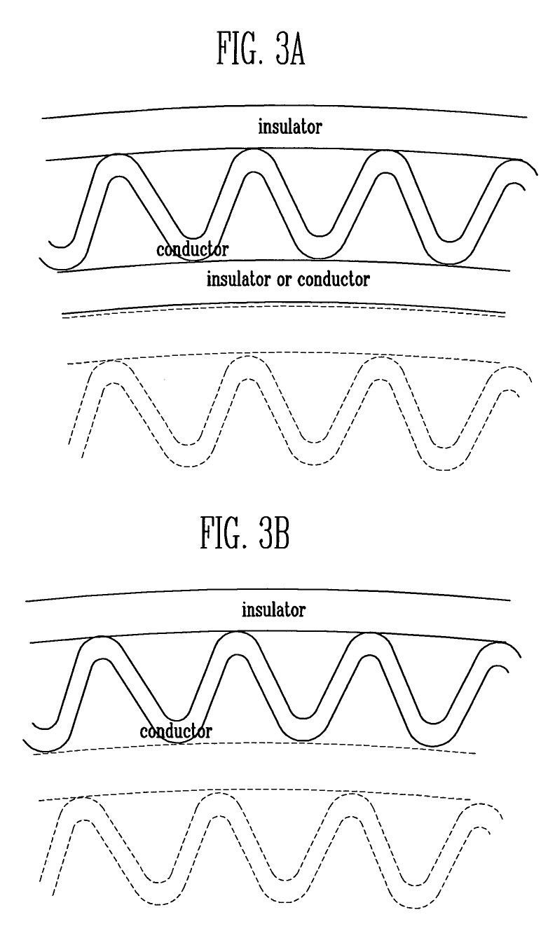

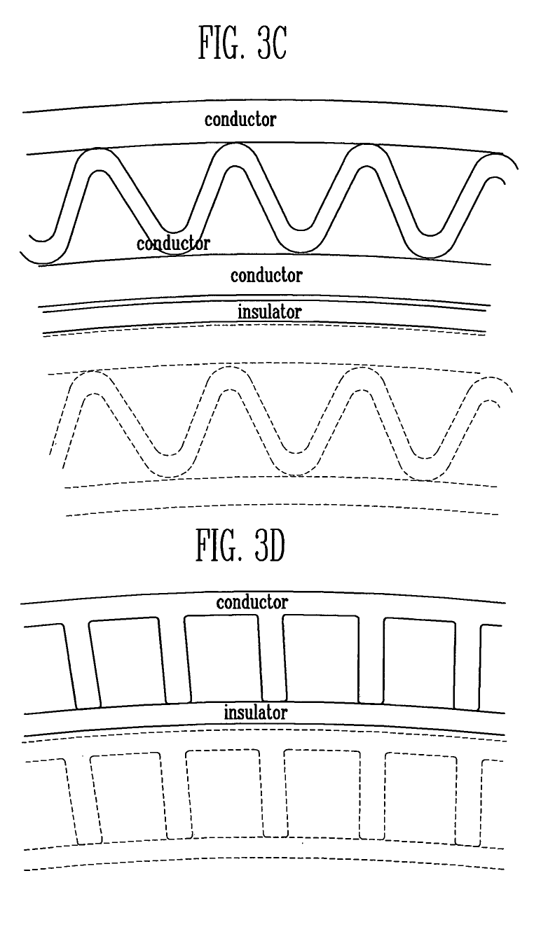

FIGS. 3A to 3D are concept views illustrating various other configurations with respect to main part of a reaction vessel constructed as another embodiment of the present invention.

Referring to FIG. 3A, one of first wall and second wall is formed of an insulating material. In this case, another one of first wall and second wall can be made of an insulating material or a conductive material. If another one of first wall and second wall is also made of an insulating material, the layer of pleats is made of a conductive material. Meanwhile, if another one of first wall and second wall is made of a conductive material, the layer of pleats can be made of a conductive material or an insulating material. In any case, at least one of first wall, second wall, and the layer of pleats is made of a conductive material. If the conductive material is a relatively low resistance material, it is preferable to form the layer of pleats with a conductive material, because the corrugated structure of the layer of pleats would produce enough electrical resistance for heating with the lower resistance conductive material.

FIGS. 3B though 3D show the variations of the configurations of the reaction vessels that can constructed according to the principles of the present invention. FIG. 3B shows a reaction vessel with a wall and a layer of pleats. In the example shown in FIG. 3B, the wall is made of an insulation material and the layer of pleats is made of a conductive material. FIG. 3C shows a reaction vessel, the structure of which is similar to the reaction vessel shown in FIG. 3A, but the walls and layer of pleats of which are all made of conductive materials. In this case, an insulation layer or an insulator is stacked with the monolith chain, and wound together with the monolith chain around an end of the monolith chain. The insulator prevents electric current from flowing in the direction of the radius of the cylinder shaped reaction vessel. FIG. 3D shows a reaction vessel that has a similar structure to the reaction vessel shown in FIG. 3B, but the layer of pleats of the reaction vessel of FIG. 3D has a different shape from the layer of pleats shown in FIG. 3B. The configurations shown in FIGS. 3A through 3D are examples, and other configurations can be available within the principles of the present invention.

An effect to obtain a means at low cost to secure reaction temperature between the reaction catalyst and inside gas at the time of initial operation is provided by using the reaction vessel and the reaction device according to the present invention of the above structure.

Further, steam reforming reaction temperature required at the time of initial operation is rapidly secured by embodying the steam reforming device according to an idea of the present invention. Therefore, an effect to improve reforming efficiency is provided.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

For example, the reaction device of the present invention can be applicable to components constituting a general reformer such as a reforming reactor, a water gas shift unit and a preferential CO oxidation unit respectively. However, it is described by embodying that the reaction device is applied to the reforming reactor, which is difficult to embody because of its highest reaction temperature, in the embodiment of FIG. 2A. It is possible to analogize that the reaction device of the present invention can be applicable to other reactors from the embodiments and it is also included in claim scope.

What is claimed is:

1. A reaction vessel to perform a chemical reaction comprising a monolithic chain having a first end and a second end, the monolith chain having a plurality of passages through which a material passes to perform the chemical reaction, the passages being formed in a direction that is not parallel to a path connecting the first end to the second end, the monolith chain comprising:
an insulating film extending from the first end to the second end; and
a conductive film extending from the first end to the second end.

2. The reaction vessel according to claim 1, wherein the monolithic chain having a first side, a second side facing the first side, a top side, and a bottom side facing the top side, the monolithic chain comprising:
a first wall formed along the first side;
a second wall formed along the second side; and
a layer of pleats interposed between the first wall and the second wall, the passages being defined by pleats of the layer of pleats, the passages being formed to have openings on each of the top side and the bottom side, at least one of the first wall and the second wall being the insulating film.

3. The reaction vessel according to claim 2, wherein the monolithic chain is positioned in the reaction vessel in a spiral shape, in which the monolithic chain is wound about an axis passing the first end in a direction parallel to the first wall.

4. The reaction vessel according to claim 2, comprised of the layer of pleats including the conductive film, the conductive film being made of a metal.

5. The reaction vessel according to claim 4, comprised of the conductive film being made of a heating metal material.

6. The reaction vessel according to claim 2, further comprising:
a first connection terminal formed on the first end of the monolithic chain to be connected to a power supplier; and
a second connection terminal formed on the second end of the monolithic chain to be connected to the power supplier.

7. The reaction vessel according to claim 2, further comprising:
a catalyst required for the chemical reaction being formed on each of the pleats of the layer of pleats.

8. The reaction vessel according to claim 7, wherein the chemical reaction is an oxidation reaction, and the catalyst includes a material selected from the group consisting of PdAl₂O₃, NiO, CuO, CeO₂ and Al₂O₃, Pu, Pd and Pt, and combinations thereof.

9. The reaction vessel according to claim 2, wherein a ratio of a total area of the openings formed on the top side of the monolithic chain to a total area of the top side of the monolithic chain is about 40% to 95%.

10. The reaction vessel according to claim 2, wherein the density of openings formed on the top side of the monolithic chain is about 200 cpi to 1500 cpi.

11. A reaction device to perform an objective reaction of gas, the reaction device comprising:
an objective reaction catalyst chamber in which the objective reaction is performed by an objective reaction catalyst to promote the objective reaction; and
a reaction vessel surrounding the objective reaction catalyst chamber, the reaction vessel including a monolithic chain having a first end, a second end, a first side, a second side facing the first side, a top side, and a bottom side facing the top side, the monolithic chain comprising:
a first wall formed along the first side;
a second wall formed along the second side; and
a layer of pleats interposed between the first wall and the second wall, a plurality of openings being formed on each of the top side and the bottom side forming a passage between the top side and the bottom side, the passage being defined by pleats of the layer of pleats, one of the first wall and the second wall being made of an insulating material.

12. The reaction device according to claim 11, wherein the objective reaction catalyst chamber includes a metal monolith that includes a plurality of passages through which the gas flows, the objective reaction catalyst being formed on walls of the passages.

13. The reaction device according to claim 11, comprised of the reaction vessel further comprising:
a first connection terminal formed on the first end of the monolithic chain to be connected to a power supplier; and
a second connection terminal formed on the second end of the monolithic chain to be connected to the power supplier, power being supplied from the power supplier to the reaction vessel for initial heating to activate an oxidation reaction in the reaction vessel.

14. The reaction device according to claim 11, wherein the monolithic chain is wound around the objective reaction catalyst chamber in a shape of a spiral.

15. The reaction device according to claim 11, comprised of the layer of pleats being made of a metal.

16. The reaction device according to claim 15, comprised of the layer of pleats being made of a heating metal material.

17. The reaction device according to claim 14, wherein a ratio of a total area of the openings formed on the top side of the monolithic chain to a total area of the top side of the monolithic chain is about 40% to 95%.

18. The reaction device according to claim 14, wherein the density of openings formed on the top side of the monolithic chain is about 200 cpi to 1500 cpi.

19. The reaction device according to claim 11, wherein the reaction vessel further including a catalyst formed on each of the pleats of the layer of pleats, and the catalyst includes a material selected from the group consisting of PdAl₂O₃, NiO, CuO, CeO₂ and Al₂O₃, Pu, Pd and Pt, and combinations thereof.

20. The reaction device according to claim 11, wherein the objective reaction is a steam reforming reaction, and the objective reaction catalyst is made of a material selected from the group consisting of Ni/Al₂O₃, Ru/ZrO₂, Ru/Al₂O₃/Ru/CeO₂—Al₂O₃, and combinations thereof.

21. The reaction device according to claim 11, wherein the objective reaction is a water gas shift reaction, and the objective reaction catalyst is made of a material selected from the group consisting of Cu, Zn, Fe, Cr, Cr₂O₃/Fe₃O₄, Cu/ZnO/Al₂O₃, and combinations thereof.

22. The reaction device according to claim 11, wherein the objective reaction is a preferential CO oxidation reaction, and the objective reaction catalyst is made of a material selected from the group consisting of Ru, Rh, Rt/Al₂O₃, TiO₂, ZrO₂, Au/Fe₂O₃, and combinations thereof.

23. The reaction device according to claim 11, wherein the reaction device reforms hydrocarbon fuel to hydrogen gas, and further comprises a pre-heater to preheat fuel received in the reaction device, the pre-heater surrounding the reaction vessel to absorb heat produced in the reaction vessel.

24. A method for heating a reforming reactor for use with a fuel cell comprising:
heating a catalyst formed in a monolithic chain by applying electrical energy to the monolithic chain for a predetermined period after the fuel cell is turned on, the monolith chains being included in a reaction vessel;
supplying a fuel and an oxidizing agent into the monolith chain to induce a chemical reaction through the catalyst; and
heating the reforming reactor with heat produced through the chemical reaction in the monolith chain.

25. The method according to claim 24, wherein the monolith chain includes a layer of pleats that defines passages through which the fuel and the oxidizing agent pass, the catalyst being formed on pleats of the layer of pleats.
